(19) United States
(12) Patent Application Publication
(10) Pub. No.: US 2022/0297082 A1
(43) Pub. Date: Sep. 22, 2022

(54) RESIDUE MITIGATION IN DIATOMACEOUS EARTH-BASED COMPOSITIONS

(71) Applicant: Church & Dwight Co., Inc., Princeton, NJ (US)

(72) Inventor: Steven T. Adamy, Lawrenceville, NJ (US)

(73) Assignee: Church & Dwight Co., Inc., Princeton, NJ (US)

(21) Appl. No.: 17/695,124

(22) Filed: Mar. 15, 2022

Related U.S. Application Data
(60) Provisional application No. 63/161,583, filed on Mar. 16, 2021.

(51) Int. Cl. B01J 20/14; B01J 20/12; B01J 20/28; B01J 20/32; A01K 1/015

(52) U.S. Cl. CPC B01J 20/14; B01J 20/12; B01J 20/28021; B01J 20/3293; B01J 20/3204; B01J 20/3234; A01K 1/0154

(57) ABSTRACT

The present disclosure provides methods and compositions for mitigating residue transfer from diatomaceous earth-based compositions. Some aspects of the disclosure provide a method of reducing residue transfer from a diatomaceous earth-based material by contacting a diatomaceous earth-based material with a content of a layered silicate solution sufficient to reduce residue transfer therefrom. Other aspects of the disclosure provide animal litter compositions including particles of a diatomaceous earth material at least partially coated by a layered silicate. Still other aspects of the disclosure provide a method of preparing an animal litter composition having reduced residue transfer, the method including forming an animal litter composition as a mixture of particles of a diatomaceous earth-based material and a layered silicate.

### FIELD OF THE DISCLOSURE

The present disclosure relates to methods and compositions for mitigating residue transfer from diatomaceous earth-based compositions and, in particular, minimizing the transfer of fines from animal litter compositions.

### BACKGROUND

Generally, diatomaceous earth (DE) based materials are used in a variety of industrial and/or commercial settings and the characteristics associated with many DE-based materials can vary. For example, DE-based materials may be present in natural settings, such as in natural formations, or they may be used in products of manufacture and other applications. In particular, DE-based materials are commonly used in foods/supplements, various household products (e.g., such as deodorants, soaps, facial scrubs, toothpastes, etc.), pest control applications, filtration applications (e.g., commonly used as a filtration aid in swimming pools), and pet litter compositions. Such DE-based materials are useful in a variety of applications due to their absorbent and mildly abrasive nature. In addition, DE-based materials are often recognized for containing an assortment of trace minerals therein. In particular, the main component in diatomaceous earth is silicon dioxide, or silica, which is known to have advantageous health and other benefits. DE-based materials typically provide excellent absorption and abrasion characteristics and are known to provide certain advantages when used in animal litter compositions, e.g., such as superior odor mitigation, high liquid absorbance capacity, and low bulk density. However, such materials are known to generate a significant amount of residue which adheres to pets and other items that come into contact with the litter composition. Accordingly, there remains a need in the field for methods of reducing residue formation and mitigating residue transfer in diatomaceous earth-based compositions.

### SUMMARY OF THE DISCLOSURE

The present disclosure relates to methods of reducing residue transfer from diatomaceous earth-based compositions (e.g., such as animal litter compositions), and compositions having reduced residue transfer characteristics when compared to other diatomaceous earth-based compositions that have not been configured according to the present disclosure. Advantageously, some embodiments of the present disclosure relate to animal litter compositions and methods of preparing such compositions that are effective to reduce a mass of particle fines adhering to a surface contacting the animal litter composition (e.g., to reduce the transfer of fines in the litter composition to a pet when contacting the litter composition).

Some aspects of the present disclosure relate to animal litter compositions capable of reducing the transfer of fines therefrom. For example, the animal litter compositions described herein may, in some embodiments, be effective to reduce a mass of particle fines adhering to a surface contacting the animal litter by at least about 5% relative to an animal litter of identical composition, but that has not been configured according to the present disclosure. In certain embodiments, such animal litter compositions may include a plurality of particles of a diatomaceous earth (DE) material and a layered silicate at least partially coating the individual particles of the DE material, the presence of the layered silicate being effective, at least in part, to cause the particles of the DE material to exhibit the improved properties described herein. In further embodiments, the animal litter compositions may be defined in relation to one or more of the following statements, which may be combined in any number or order.

The layered silicate can be selected from the group consisting of Laponite RD, Laponite DF, Laponite DS, Laponite RDS, and combinations thereof.

The layered silicate can be present in an amount of about 1% to about 3% by dry weight, based on the total dry weight of the coated DE material.

The litter composition can further comprise one or more additives selected from the group consisting of fillers, clumping agents, de-dusting agents, fragrances, bicarbonates, binders, and preservatives.

The animal litter composition can be effective to reduce a mass of particle fines adhering to a surface contacting the animal litter by at least about 5% relative to an animal litter of identical composition, but that does not include the layered silicate.

In another aspect, the present disclosure provides a method of reducing transfer of fines from a particulate composition. Such methods may comprise contacting particles of a diatomaceous earth (DE)-based material with a content of a solution comprising a layered silicate in an aqueous solvent so that the layered silicate is at least partially coated on the particles of the DE-based material, the presence of the layered silicate on the particles of the DE-based material being effective to reduce transfer of fines of the DE-based material from the particles to a surface contacting the particles. In further embodiments, the methods may be defined in relation to one or more of the following statements, which may be combined in any number or order.

The particulate composition can be a pet litter composition and the presence of the layered silicate on the particles of the DE-based material is effective to reduce the transfer of fines of the DE-based material from the particles to a pet surface contacting the particles in the pet litter composition.

The solution can be in the form of a sol or gel.

The aqueous solvent can be water.

The layered silicate can be selected from the group consisting of Laponite RD, Laponite DF, Laponite DS, Laponite RDS, and combinations thereof.

The solution can comprise about 0.1% to about 10% layered silicate by weight, based on the total weight of the solution.

The presence of the layered silicate on the particles of the DE-based material can be effective to reduce the mass of particle fines adhering to a surface contacting the pet litter by at least about 5% relative to a pet litter of identical composition but that does not include the layered silicate.

In another aspect, the present disclosure provides a method of preparing an animal litter composition. Such methods may comprise, for example, combining particles of a diatomaceous earth (DE)-based material with a layered silicate such that the layered silicate at least partially coats, individually, at least a portion of the particles of the DE-based material. In further embodiments, the methods may be defined in relation to one or more of the following statements, which may be combined in any number or order.

The method can further comprise combining the particles of the DE-based material including the layered silicate with one or more additives selected from the group consisting of fillers, clumping agents, de-dusting agents, fragrances, bicarbonates, binders, and preservatives.

The layered silicate can in the form of a sol or gel when combined with the particles of the DE-based material.

The method can further comprise drying the animal litter composition after combination of the particles of the DE-based material with the layered silicate.

The layered silicate can be provided as a solution of the layered silicate in an aqueous solvent.

The layered silicate can be selected from the group consisting of Laponite RD, Laponite DF, Laponite DS, Laponite RDS, and combinations thereof.

The layered silicate solution can comprise about 0.1% to about 10% layered silicate by weight, based on the total weight of the layered silicate solution.

The layered silicate can be combined with the particles of the DE-based material in a sufficient amount to reduce the mass of particle fines adhering to a surface contacting the animal litter composition by at least about 5% relative to an animal litter composition of identical composition but that does not include the layered silicate.

The layered silicate can be combined with the particles of the DE-based material in a sufficient amount so that the layered silicate is present in the animal litter composition in an amount of about 1% to about 3% by dry weight, based on the total dry weight of the coated DE-based material.

These and other features, aspects, and advantages of the present disclosure will be apparent from a reading of the following detailed description together with the accompanying drawings, which are briefly described below. The present disclosure includes any combination of two, three, four, or more features or elements set forth in this disclosure or recited in any one or more of the claims, regardless of whether such features or elements are expressly combined or otherwise recited in a specific embodiment description or claim herein. This disclosure is intended to be read holistically such that any separable features or elements of the disclosure, in any of its aspects and embodiments, should be viewed as intended to be combinable, unless the context of the disclosure clearly dictates otherwise.

### BRIEF DESCRIPTION OF THE FIGURES

Having thus described the disclosure in general terms, reference will now be made to the accompanying drawings, which are not necessarily drawn to scale, and wherein:

FIG. 1A provides microscopic images showing the amount of residue/fines transferred from a surface placed in contact with various samples of coated diatomaceous earth (e.g., each sample having varying amounts, if any, of a layered silicate applied thereto), according to an example embodiment of the present disclosure;

FIG. 1B provides microscopic images showing the amount of residue/fines transferred from a surface placed in contact with various samples of coated diatomaceous earth (e.g., each sample having varying amounts, if any, of a layered silicate applied thereto), according to an example embodiment of the present disclosure;

FIG. 2 provides microscopic images showing the amount of residue/fines transferred from a surface placed in contact with various samples of coated diatomaceous earth having undergone simulated attrition (e.g., each sample having varying amounts, if any, of a layered silicate applied thereto), according to an example embodiment of the present disclosure;

FIG. 3 illustrates a plot of the percent area covered by residue/fines for each tested sample of coated diatomaceous earth, according to an example embodiments of the present disclosure;

FIG. 4 provides microscopic images showing the amount of residue/fines transferred from a surface placed in contact with various samples of coated diatomaceous earth having undergone simulated attrition (e.g., including a control sample, samples having varying amounts of a layered silicate applied thereto, and samples having a non-layered silicate applied thereto), according to an example embodiment of the present disclosure;

FIG. 5 illustrates a plot of the percent area covered by residue/fines for each tested sample of coated diatomaceous earth.

### DETAILED DESCRIPTION OF THE DISCLOSURE

The present disclosure now will be described more fully hereinafter with reference to specific embodiments. Indeed, the disclosure may be embodied in many different forms and should not be construed as limited to the embodiments set forth herein; rather, these embodiments are provided so that this disclosure will satisfy applicable legal requirements. As used in the specification, and in the appended claims, the singular forms “a,” “an,” “the,” include plural referents unless the context clearly dictates otherwise.

The present disclosure relates to animal litter compositions and methods of preparing such compositions. The presently disclosed methods and compositions can be particularly beneficial in that they can provide the ability to reduce or mitigate residue transfer in diatomaceous earth (DE)-based materials and, in particular, in animal litter compositions including such DE-based materials. As used herein, “residue” generally refers to fine particulate matter (i.e., fines) present in litter compositions as described herein that may adhere to a surface contacting the litter composition. The terms “fines” and “residue” are used interchangeably herein and are intended to refer to any finely crushed or powdered material, e.g., such as very small particles in a mixture of various sizes. Advantageously, the animal litter compositions and methods of preparing such compositions as described herein are effective to reduce a mass of particle fines adhering to a surface contacting the animal litter composition (e.g., to reduce the transfer of fines in the litter composition to a pet when contacting the litter composition).

Some aspects of the present disclosure relate to diatomaceous earth-based materials material. The types of diatomaceous earth-based materials may vary and generally, the methods of reducing and/or mitigating residue transfer therefrom are intended to be suitable for any number of DE-based materials and applications thereof. For example, DE-based materials are commonly used in a variety of foods/supplements, various household products (e.g., such as deodorants, soaps, facial scrubs, toothpastes, etc.), and pest control applications. A further non-limiting example of a product including a DE-based material suitable for modification according to the present disclosure can include pet litters, and more particularly cat litters. Such DE-based materials are useful in a variety of applications due to their absorbent and mildly abrasive nature. In particular, DE-based materials typically provide excellent absorption and abrasion characteristics and are known to provide certain advantages when used in animal litter compositions, e.g., such as superior odor mitigation, high liquid absorbance capacity, and low bulk density.

In some embodiments, performance of an animal litter composition can be improved though use of a DE-based material exhibiting a defined particle size range. For example, suitable DE-based materials can be provided with an average particle size of about 0.2 mm to about 5 mm, about 0.3 mm to about 4 mm, or about 0.5 mm to about 3 mm. In some embodiments, the surface area of each particle of the DE-based material may comprise a defined surface area that that has been found to maximize effectiveness of the animal litter composition in exhibiting reduced adhesion to surfaces when the litter is wetted. For example, particles of the DE-based material can have an average surface area that is less than 20 m²/g, less than 15 m²/g, or less than 10 m²/g. In each of the foregoing ranges, it is understood that the particles preferably have a minimum surface area of at least 1 m²/g. In some embodiments, the particles of the DE-based material can have an average surface of about 1 m²/g to about 20 m²/g, about 2 m²/g to about 15 m²/g, or about 3 m²/g to about 10 m²/g. Surface area can be measured utilizing known methods, such as the Brunauer, Emmett, Teller (“BET”) method wherein surface area is calculated using N₂ absorption. The above values, in some embodiments, thus may be referred to as the BET surface area.

The amount of the DE-based material used in the present animal litter composition can vary. For example, the DE-based material can form about 15% by weight to about 99.5% by weight of the composition. In further embodiments, the amount of the DE-based material in the animal litter composition can be about 20% by weight to about 94% by weight, about 25% by weight to about 90% by weight, about 30% by weight to about 80% by weight, or about 35% by weight to about 55% by weight based on the total weight of the composition.

The animal litter composition also includes a layered silicate in addition to the individual particles of DE-based material. In one or more embodiments as described herein, the particles of DE-based material may have been treated with a layered silicate solution (e.g., a layered silicate in an aqueous solvent) such that the layered silicate at least partially coats, individually, at least a portion of the individual particles of the DE material after drying. As used herein, a “layered silicate” or “layered silicate material” refers to its typical meaning in physical chemistry, for example, a natural inorganic compound of variable chemical composition composed of planar layers of octahedra sheets bound to tetrahedra sheets forming a two-dimensional (i.e., layered) sheet structure. Typically, layered silicates belong to the group of minerals known as “phyllosilicates” which is a subclass of the “silicate” family. The phyllosilicate subclass may be characterized as having a silicon to oxygen ratio of 1:2.5 or 2:5 because only one oxygen is exclusively bonded to the silicon and the other three oxygens are shared with other silicon.

In some embodiments, the layered silicate material may comprise a phyllosilicate. Examples of phyllosilicates include, but are not limited to, allophane, apophyllite, bannisterite, carletonite, cavansite, chrysocolla, the clay group of phyllosilicates (e.g., including chlorites; such as baileychlore, chamosite, chlorite, clinoclore, cookeite, nimite, pennantite, penninite, and sudoite; and other clay silicates; such as glauconite, illite, kaolinite, montmorillonite, palygorskite, pyrophyllite, sauconite, talc, and vermiculite), delhayelite, elipidite, fedorite, franklinfurnaceite, franklinphilite, gonyerite, gyrolite, leucosphenite, the mica group of phyllosilicates (e.g., including biotite, lepidolite, muscovite, paragonite, phlogopite, and zinnwaldite), minehillite, nordite, pentagonite, petalite, prehnite, rhodesite, sanbornite, the serpentine group of phyllosilicates (e.g., including antigorite, clinochrysotile, lizardite, orthochrysotile, and serpentine), wickenburgite, and zeophyllite.

In certain embodiments, the layered silicate material may comprise Laponite. Laponite is a layered, synthetic smectite clay also known as lithium sodium magnesium silicate, commercially available from the BYK® Additives and Instruments Division of ALTANA® AG (headquartered in Wesel, Germany). Generally, Laponite is manufactured commercially under various different grades having a variety of characteristics and applications; e.g., such as Laponite RD, Laponite RDS, Laponite S482, Laponite SL25, Laponite EP, Laponite JS, Laponite XLG, Laponite XLS, Laponite XL21, Laponite D, Laponite DF, Laponite DS, and others. In some embodiments, for example, the layered silicate material may comprise Laponite RD, Laponite DF, Laponite DS, Laponite RDS, and combinations thereof.

In some embodiments, the layered silicate may be present in an amount of at least 1% by dry weight, at least 2% by dry weight, at least 3% by dry weight, at least 4% by dry weight, or at least 5% by dry weight, based on the total dry weight of the coated DE-based material. In some embodiments, the layered silicate may be present in an amount in the range of about 0.1% to about 10% by dry weight, about 0.5% to about 5% by dry weight, or about 1% to about 3% by dry weight, based on the total dry weight of the coated DE-based material.

As noted above, in one or more embodiments, the layered silicate may be provided as a solution of the layered silicate in an aqueous solvent when combined with the particles of the DE-based material. Typically, the aqueous solvent is water. However, other solvents which are fully miscible with water (e.g., some alcohols, such as polyhydric alcohols, and some glycol ethers) may be used as long as the water content of the aqueous phase is sufficient to hydrate the layered silicate to the desired viscosity. Typically, when the layered silicate is mixed with the aqueous solvent (e.g., water or other suitable solvent), it disperses rapidly within the aqueous solvent forming a colloidal dispersion. In some embodiments, this colloidal dispersion may have varying properties or physical characteristics. For example, in some embodiments, the layered silicate solution may be provided in the form of a sol when prepared and, in other embodiments, the layered silicate solution may be provided in the form of a gel when prepared. As used herein, a “sol” refers to its typical meaning in physical chemistry, for example, a colloid (aggregate of very fine particles dispersed in a continuous medium) in which the particles are solid and the dispersion medium is fluid. Generally, a sol composition may be characterized as the liquid state of a colloidal solution. As used herein, a “gel” refers to its typical meaning in physical chemistry, for example, a colloid (aggregate of very fine particles dispersed in a continuous medium) in which the particles are solid and the dispersion medium is in a solid or semi-solid state. Generally, a gel composition may be characterized as the solid or semi-solid (e.g., jelly-like) state of a colloidal solution. In some embodiments, a gel composition may be characterized as having a higher viscosity than a sol composition. In some embodiments, a gel composition may be characterized as having a fully or partially defined structure whereas a sol composition generally does not have a defined structure.

Generally, when the layered silicate is provided as a solution, the concentration of the layered silicate material within that solution may vary. For example, the layered silicate solution may include a concentration of the layered silicate material of at least about 2% by weight, at least about 4% by weight, at least about 6% by weight, at least about 8% by weight, or at least about 10% by weight, based on the total weight of the layered silicate solution. In some embodiments, the layered silicate may include a concentration of the layered silicate material in the range of about 1% to about 20% by weight, about 2.5% to about 15% by weight, or about 5% to about 10% by weight, based on the total weight of the layered silicate solution.

In some embodiments, the animal litter compositions of the present disclosure may comprise at least about 70%, at least about 80%, at least about 90%, at least about 95%, or at least about 99% of the coated DE-based material (i.e., coated at least partially with a layered silicate). In certain embodiments, for example, animal litter compositions according to the disclosure may include 100% of the coated DE-based material. In other embodiments, the animal litter composition may include one or more additional components in addition to the coated DE-based material.

In one or more embodiments, for example, the animal litter composition may also include one or more clumping agents, or clump enhancing materials. Description of suitable clumping agents is provided in U.S. Pat. No. 8,720,375 to Miller et al., the disclosure of which is incorporated herein by reference. Useful clumping agents are those materials suitable to promote adhesion of the fine size particles of litter granules to each other as well as adhesion of the particles to form agglomerates when wetted. Preferably, the clumping agent allows the formation of a gelled agglomerate when exposed to a liquid, such as animal urine. A clumping agent may be provided in admixture (e.g., in particle form) with the further particles forming the animal litter. In some embodiments, the clumping agent can be provided as a coating on at least a portion of the other particles forming the animal litter (e.g., as a coating on at least a portion of the filler material). Such coatings may be provided by any known method, such as spraying.

Non-limiting examples of materials suitable for use as a clumping agent include naturally occurring polymers (e.g., naturally occurring starches, water soluble polysaccharides, and gums), semisynthetic polymers (e.g., cellulose derivatives, such as carboxymethyl cellulose), and sealants. Exemplary clumping agents include amylopectins, natural gums, and sodium carboxymethylcellulose. The amount of any clumping agent that is present in the animal litter composition can vary based upon the total composition. For example, it can be useful to include a greater amount of clumping agents when a greater amount of non-absorbent fillers is used. In some embodiments, the amount of clumping aid can be adjusted based on the amount of ionic liquid in the animal litter composition in order to further optimize the clumping behavior of the animal litter composition. In some embodiments, clumping agents can be present in a total amount of 0.1% by weight to about 6% by weight, about 0.2% by weight to about 5.5% by weight, about 0.3% by weight to about 5% by weight, or about 0.5% by weight to about 4% by weight.

In one or more embodiments, the animal litter composition may also include one or more fillers. Fillers suitable for use in the present animal litter compositions can include a variety of materials that can be a non-absorbent, non-soluble substrate, or can be an absorbent substrate. In one or more embodiments, useful fillers can include absorbent substrates, such as non-clumping clays. Non-limiting examples of useful non-clumping clays include attapulgite, Fuller's earth, calcium bentonite, palygorskite, sepiolite, kaolinite, illite, halloysite, hormite, vermiculite or mixtures thereof. Suitable fillers according to the present disclosure also can include a variety of non-absorbent, non-soluble substrates, such as non-clay substances. Such non-clay substances may, in some embodiments, include organic or inorganic absorbants including, but not limited to, soybean meal, soybean hulls, cottonseed meal, cotton seed hulls, canola meal, sunflower seed meal, linseed meal, safflower meal, rolled oats, crimped oats, pulverized oats, oat hulls, reground oat feed, rice bran, rice millfeed, and rice hulls, beet pulp pellets, beet pulp shreds, citrus pulp pellets, barley feed, feed wheat, milo, and ground grain screenings, wheat shorts, what brand, wheat middlings, wheat millrun, alfalfa meal, corn hominy feed, corn cobs, distillers dried grains, malt sprouts, and brewers dried grains. Other non-limiting examples of non-clay materials that can be used include zeolites, crushed stone (e.g., dolomite and limestone), gypsum, sand, calcite, recycled waste materials, silica, corn cob, wheat, extruded and/or cross-linked starches, ground cellulosic plant materials, wheat straw, and the like.

In some embodiments, it can be useful to provide the filler material in a form exhibiting specific characteristics. For example, it can be useful for the filler material to exhibit an average particle size that is approximately the same as the DE-based material particles. In particular, the filler material may exhibit an average particle size that is +/−20%, +/−15%, +/−10%, or +/−5% of the average particle size of the DE-based material particle size. In some embodiments, it likewise can be useful for the filler material to have an average surface area that is approximately the same as the surface area of the DE-based material particles. The above tolerances thus likewise can apply to surface area.

The amount of the filler used in the present animal litter composition can vary. In some embodiments, filler may be expressly excluded (i.e., forming 0% of the litter composition). Preferably, the filler provides the balance of the animal litter composition after all other materials are included. As examples, the animal litter composition can comprise about 0% by weight to about 75% by weight, about 10% by weight to about 70% by weight, about 25% by weight to about 65% by weight, or about 40% by weight to about 60% by weight of the filler based on the total weight of the animal litter composition.

In one or more embodiments, the animal litter composition may include a clay-based liquid absorbing material. A clay based liquid-absorbing material for use in an animal litter composition as described herein can include any such material previously recognized as useful in forming animal litters. For example, the clay-based liquid absorbing material may be a naturally clumping clay. In some embodiments, a comminuted bentonite, or more particularly a sodium bentonite, which contains a preponderant amount of montmorillonite clay mineral, may be used as the clay-based liquid absorbing material in the present animal litter composition. Non-limiting examples of bentonite clays that can be used include sodium bentonite, potassium bentonite, lithium bentonite, calcium bentonite and magnesium bentonite, or combinations thereof. Clay-based liquid absorbing materials useful in the present animal litter compositions are further described in U.S. Pat. No. 8,720,375 to Miller et al., the disclosure of which is incorporated herein by reference.

In some embodiments, it can be useful to provide the clay-based liquid absorbing material in a form exhibiting specific characteristics. For example, it can be useful for the clay-based liquid absorbing material to exhibit an average particle size that is approximately the same as the DE-based material particles. In particular, the clay-based liquid absorbing material may exhibit an average particle size that is +/−20%, +/−15%, +/−10%, or +/−5% of the average particle size of the DE-based material particle size. In some embodiments, it likewise can be useful for the clay-based liquid absorbing material to have an average surface area that is approximately the same as the surface area of the DE-based material particles. The above tolerances thus likewise can apply to surface area.

The amount of the clay-based liquid absorbing material used in the present animal litter composition can vary. In some embodiments, a clay-based liquid absorbing material may be expressly excluded (i.e., forming 0% of the litter composition). Alternatively, the clay-based liquid absorbing material may provide the balance of the animal litter composition after all other materials are included. As examples, the animal litter composition can comprise about 0% by weight to about 75% by weight, about 10% by weight to about 70% by weight, about 25% by weight to about 65% by weight, or about 40% by weight to about 60% by weight of the clay-based liquid absorbing material based on the total weight of the animal litter composition.

In addition to the foregoing, one or more further materials may be included in the present animal litter composition. Specifically, any conventional litter additive may be included to the extent that there is no interference with the ability of the litter composition to provide the useful effect of reduced adherence to surfaces when wetted. Non-limiting examples of additional materials that may be used include binders, preservatives, such as biocides (e.g., benzisothiazolinone, methylisothiazolone), de-dusting agents, fragrance, bicarbonates, and combinations thereof. Each of the foregoing materials separately may be included in any amount up to about 5% by weight, up to about 2% by weight, up to about 1% by weight, or up to about 0.5% by weight, such as about 0.01% by weight to about 5% by weight, to about 4% by weight, to about 3% by weight, to about 2% by weight, or to about 1% by weight based on the total weight of the animal litter composition. Further, it is understood that any one or more of such materials may be expressly excluded from the present animal litter composition.

These particular formulations and combinations of components are not to be construed as limiting and the specific amounts of individual components may vary based on the desired flow characteristics, permeation depth, and/or other factors. The animal litter compositions described herein may be used for a wide variety of animals and birds, such as cats, dogs, hamsters, gerbils, rabbits, guinea pigs, mice, rats, ferrets, chickens, ducks, geese, parrots, parakeets, canaries, pigeons, and other animals where a scoopable and/or replaceable litter composition may be useful for sanitary purposes or the like. The compositions of this invention are particularly suitable for use as cat litters.

As noted above, the present disclosure also provides methods for preparing an animal litter composition. In some embodiments, such methods may comprise combining particles of a diatomaceous earth (DE)-based material with a layered silicate such that the layered silicate at least partially coats, individually, at least a portion of the particles of the DE-based material. As noted above, in certain embodiments, the layered silicate may be provided as a solution of the layered silicate in an aqueous solvent and, more particularly, this solution may be a colloidal dispersion of the layered silicate in the aqueous solvent (e.g., such that the layered silicate solution is in the form of a “sol” or a “gel”). It should be noted that any layered silicate material, and any amount thereof, as described herein above would be suitable for use in the methods described herein. In some embodiments, for example, the layered silicate solution may have a concentration in the range of about 0.1% to about 10% layered silicate by weight, based on the total weight of the layered silicate solution, when combined with the particles of DE-based material.

When the layered silicate is applied to DE-based material as a solution, it may also be necessary to dry the treated DE-based material for a period of time to remove any excess moisture therefrom. The amount of time and/or the temperature of such a drying step may vary and is generally understood to be an amount of time sufficient to remove any excess moisture from the animal litter composition.

In some embodiments, one or more additives as described herein may be added to the animal litter composition. Such additives may include, but are not limited to, fillers, clumping agents, de-dusting agents, fragrances, bicarbonates, binders, and preservatives. Typically, the one or more additives may be combined with the animal litter composition after the particles of the DE-based material have been treated with the layered silicate solution and after any subsequent drying step. However, in some embodiments, one or more of the additives may be added to the particles of DE-based material prior to combination with the layered silicate and/or prior to any drying steps.

The presently disclosed methods and compositions can be particularly beneficial in that they can reduce the transfer of fines from a pet litter composition as noted herein. In particular, the present disclosure provides a method comprising contacting particles of a diatomaceous earth (DE)-based material with a content of a solution comprising a layered silicate in an aqueous solvent so that the layered silicate is at least partially coated on the particles of the DE-based material, the presence of the layered silicate on the particles of the DE-based material being effective to reduce transfer of fines of the DE-based material from the particles to a pet contacting the particles when present in a pet litter. In some embodiments, the layered silicate material may be combined with the particles of the DE-based material in a sufficient amount to reduce a mass of particle fines adhering to a surface contacting the animal litter by at least about 5%, at least about 10%, at least about 15%, at least about 20%, at least about 25%, or at least about 30%, relative to an animal litter of identical composition, but that does not include the layered silicate. Typically, a sufficient amount of the layered silicate is defined as any amount provided in the animal litter compositions described herein above (e.g., about 0.1% to about 10% by dry weight, about 0.5% to about 5% by dry weight, or about 1% to about 3% by dry weight, based on the total dry weight of the coated DE-based material).

### EXPERIMENTAL

Aspects of the present invention are more fully illustrated by the following examples, which are set forth to illustrate certain aspects of the present invention and are not to be construed as limiting thereof.

### Example 1

Testing was conducted to evaluate the effectiveness of layered silicates in reducing residue/fines transfer when applied to particles of diatomaceous earth. In particular, various grades of Laponite (e.g., Laponite RD, Laponite DF, Laponite RDS, and Laponite DS) were evaluated.

First, four layered silicate solutions were prepared by mixing each of the four Laponite grades with deionized water while continuously stirring the solutions with an overhead mixer. The Laponite was added slowly to the mixer and stirring continued until full dissolution of the Laponite was observed. It was observed that samples 1 and 2 (i.e., including Laponite RD and Laponite DF, respectively) were in the form of a gel and samples 3 and 4 (i.e., including Laponite RDS and Laponite DS, respectively) were in the form of a sol, having viscosities on the order of 10² centipoise (cP). Each of the four solutions was prepared with a concentration of 5.0 weight percent Laponite based on the total weight of the layered silicate solution. Table 1 below represents each of the four layered silicate solutions prepared.

TABLE 1

| Sample 5406- 91- | Wt. % Laponite RD | Wt. % Laponite DF | Wt. % Laponite RDS | Wt. % Laponite DS | Wt. % Deionized Water |
|---|---|---|---|---|---|
| 1 | 5.0 | | | | 95.0 |
| 2 | | 5.0 | | | 95.0 |
| 3 | | | 5.0 | | 95.0 |
| 4 | | | | 5.0 | 95.0 |

Following preparation of the four layered silicate solutions, ten samples were prepared by mixing the layered silicate solutions with 6.0 g of diatomaceous earth (DE) in a 50 mL plastic centrifuge tube. After addition of the layered silicate solution to the tube, the tube was shaken rapidly for a few seconds and then vortexed for about 10 seconds on high speed to ensure complete mixing. The resulting solid samples (including the DE material and the Laponite solution) were then removed from the tube and placed on a watch glass. The samples were oven-dried overnight at 50° C. Amounts of each of the layered silicate solution added to the samples shown in Table 2 below. These amounts are expressed in terms of parts per hundred (pph); i.e., parts of Laponite solution added to 100 parts of DE. In addition, a control sample (sample 5) was prepared in which only deionized water was added to the DE material.

TABLE 2

| Sample 5406- 91- | 5406-91-1 added to DE (pph) | 5406-91-2 added to DE (pph) | 5406-91-3 added to DE (pph) | 5406-91-4 added to DE (pph) | Deionized water added to DE (pph) |
|---|---|---|---|---|---|
| 1A | 100 | | | | |
| 1B | 200 | | | | |
| 2A | | 100 | | | |
| 2B | | 200 | | | |
| 3A | | | 100 | | |
| 3B | | | 200 | | |
| 3C | | | 50 | | |
| 4A | | | | 100 | |
| 4B | | | | 200 | |
| 4C | | | | 50 | |
| 5 | | | | | 100 |

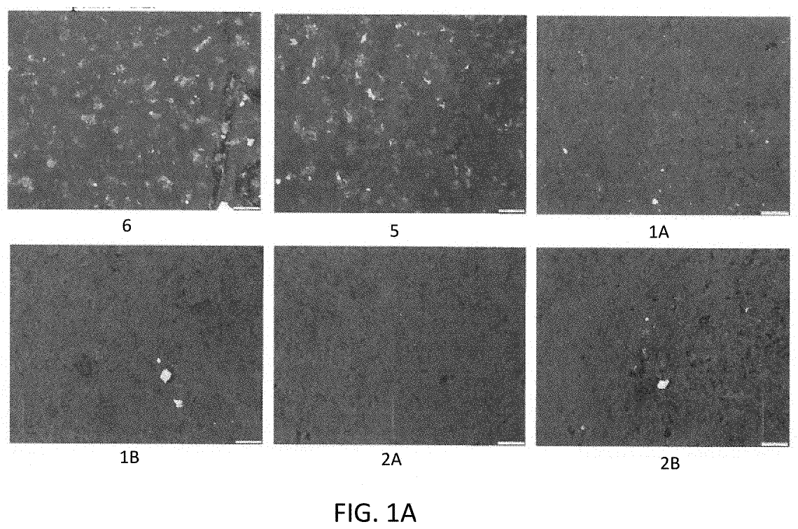

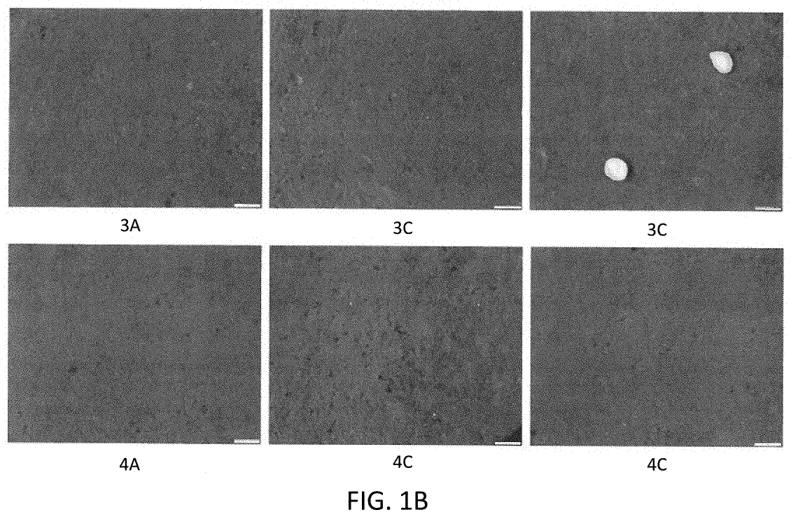

The above samples were evaluated for residue transfer by placing a number 6 rubber stopper (wide side down) on top of the DE/Laponite mixture in a large weight boat. A 1 kg mass was then placed on top of the stopper and allowed to sit for 15 seconds. The stopper was then removed from the large weight boat and the surface of the stopper which was exposed to the DE/Laponite mixture was then imaged under a microscope at a magnification of 7 times. FIGS. 1A and 1B provide a representative microscope image of each of the tested samples as well as a sample of un-treated DE material that will be referred to herein as sample 6. It should be noted that samples 3B and 4B were not imaged because these samples resulted in unusable dried mud cakes, rather than individual particles transferred to the rubber stopper. As shown in FIG. 7, in both the non-treated sample (sample 6) and the water-only treated sample (sample 5), significant levels of residue were seen on the stopper surface. By contrast, in most of the Laponite-treated samples, little to no residue was observed. It should be noted that larger particles were observed in sample 3C; however, it is presumed that such larger particles would more easily break free from the surface (e.g., a pet's foot/paw) in practice.

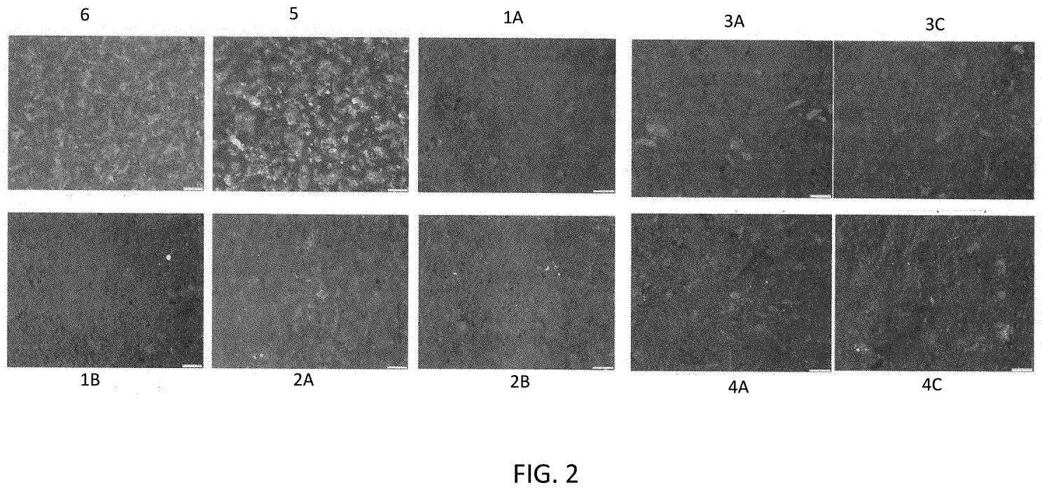

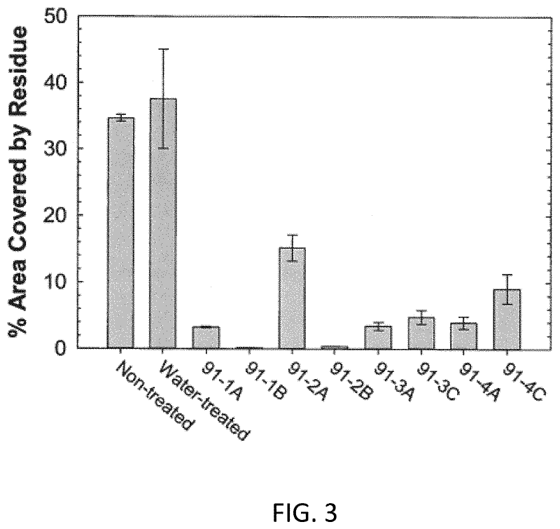

Next, in order to simulate exposure of the DE-material to forces which could cause attrition of the particles during use (e.g., transportation, mixing, and carton filing), studies were performed in which the DE/Laponite samples were placed under stress. Ten new samples were prepared in accordance with the steps provided herein above and using the exact same parameters for each sample as listed in Table 2. The only exception is that six steel balls, having a diameter of 0.25 inches (6.53 mm) were placed in the plastic centrifuge tubes and mounter to a shaker set on the maximum setting of 10. The samples were shaken for 10 minutes while in contact with the steel balls to simulate attrition, prior to application of the rubber stopper and subsequent microscope imaging. FIG. 2 provides a representative microscope image of each of the tested samples as well as a sample of un-treated DE material that will be referred to herein as sample 6. As observed during testing of the non-attritioned samples, the attritioned samples treated with Laponite likewise exhibited visual reduction in the transfer of residue to the stopper. In order to quantify the difference between the imaged samples, image analyses were performed on each of the samples using ImageJ software, an open source Java image processing program developed by the National Institutes of Health (NIH) Image. The results of the image analyses are illustrated in FIG. 3, which shows a plot of the percent area covered by residue in the imaged sample. The values in FIG. 3 represent an average of the percent area covered assessed from two images per sample. As shown in FIG. 3, all sample treated with Laponite exhibited significantly lower degrees of residue transfer when compared to the non-treated control sample (sample 6) and the water-only treated control sample (sample 5). In particular, samples 2A and 4C exhibited a reduction in the percent area covered by residue of at least 20% and all other samples exhibited a reduction in the percent area covered by residue of at least 30% when compared to the control samples.

### Example 2

Additional testing was conducted to evaluate the effectiveness of layered silicate solutions having varying concentrations of Laponite RDS in reducing residue/fines transfer when applied to particles of diatomaceous earth. In addition, an amorphous silicate solution (e.g., referred to as Silicate N) was evaluated for effectiveness in reducing residue/fines transfer when applied to particles of diatomaceous earth.

First, two layered silicate solutions (samples A and B) were prepared by mixing Laponite RDS with deionized water while continuously stirring with an overhead mixer. The Laponite RDS was added slowly to the mixer and stirring continued until full dissolution of the Laponite was observed. Sample A was prepared with a concentration of 5.0 wt. % Laponite RDS, based on the total weight of the layered silicate solution. Sample B was prepared with a concentration of 10.0 wt. % Laponite RDS, based on the total weight of the layered silicate solution. Next, non-layered silicate solution (sample C) was prepared by mixing Silicate N (an amorphous silicate) with deionized water while continuously stirring with an overhead mixture. Sample C was prepared with a concentration of 5.0 wt. % Silicate N, based on the total weight of the non-layered silicate solution. Table 3 below represents each of the three solutions prepared.

TABLE 3

| Sample | Wt. % Laponite RDS | Wt. % of Silicate N (37.83% solids) | Wt. % Deionized Water |
|---|---|---|---|
| A | 5.0 | | 95.0 |
| B | 10.0 | | 90.0 |
| C | | 13.22 | 86.78 |

Following preparation of the three solutions, samples were prepared by mixing the solutions with 500.0 g of diatomaceous earth (DE) in a tabletop mixer. The solutions were added slowly to the DE with a pipette (with the tabletop mixer powered on) to ensure adequate mixing. The samples were mixed until visual uniformity was observed. The resulting solid samples (including the DE material and the respective solutions) were then removed from the mixer and placed in a glass baking dish. The samples were then oven-dried overnight at 50° C. Amounts of each of the solutions added to the samples shown in Table 4 below. These amounts are expressed in terms of grams of solution and grams of DE. In addition, the percentage of the layered silicate and the percentage of the non-layered amorphous silicate in the sample, expressed on a dry weight basis, is provided in the last two columns of Table 4. In addition, a control sample (sample 9) was prepared in which only deionized water was added to the DE material.

TABLE 4

| | | Mass | Mass 5% | Mass | | % RDS | % Amorphous |
|---|---|---|---|---|---|---|---|
| | Mass 5% | 10% | Silicate | Deionized | Mass DE | Dry | Silicate Dry |
| Sample | RDS (g) | RDS (g) | (N) (g) | Water g) | (g) | Basis | Basis |
| 1 | 125.00 | | | | 500.00 | 1.23 | |
| 2 | 187.50 | | | | 500.00 | 1.84 | |
| 3 | 250.00 | | | | 500.00 | 2.40 | |
| 4 | | 62.50 | | | 500.00 | 1.23 | |
| 5 | | 93.75 | | | 500.00 | 1.84 | |
| 6 | | 125.00 | | | 500.00 | 2.40 | |
| 7 | | | 500.00 | | 500.00 | | 4.80 |
| 8 | | | 250.00 | | 500.00 | | 2.40 |
| 9 | | | | 250.00 | 500.00 | — | — |

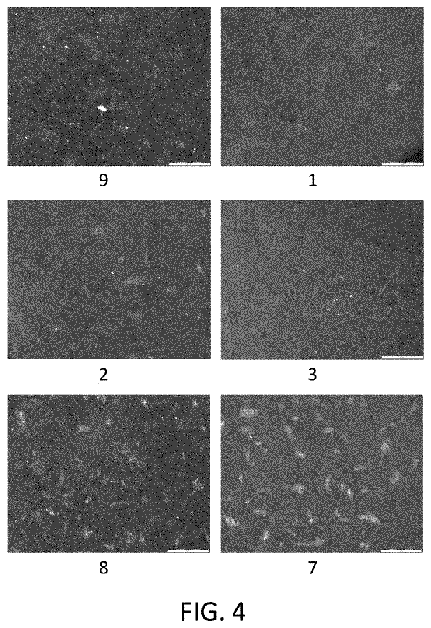

Next, in order to simulate exposure of the DE-material to forces which could cause attrition of the particles during use (e.g., transportation, mixing, and carton filing), studies were performed in which the samples were placed under stress. About 6.0 grams of each of the nine samples in Table 4 were separately placed in a 50 mL plastic centrifuge tube and six steel balls, having a diameter of 0.25 inches (6.53 mm), were placed in the plastic centrifuge tubes and mounter to a shaker set on the maximum setting of 10. The samples were shaken for 10 minutes while in contact with the steel balls to simulate attrition. After shaking the samples, residue transfer was evaluated by placing a number 6 rubber stopper (wide side down) on top of the samples in a large weight boat. A 1 kg mass was then placed on top of the stopper and allowed to sit for 15 seconds. The stopper was then removed from the large weight boat and the surface of the stopper which was exposed to the samples was then imaged under a microscope at a magnification of 7 times. FIG. 4 provides a representative microscope image of each of the tested samples. As shown in FIG. 4, all samples that were treated with the layered silicate solution (samples 1-3) exhibited a reduced amount of residue compared to the samples treated with the non-layered amorphous silicate (samples 7 and 8) and water only (sample 9).

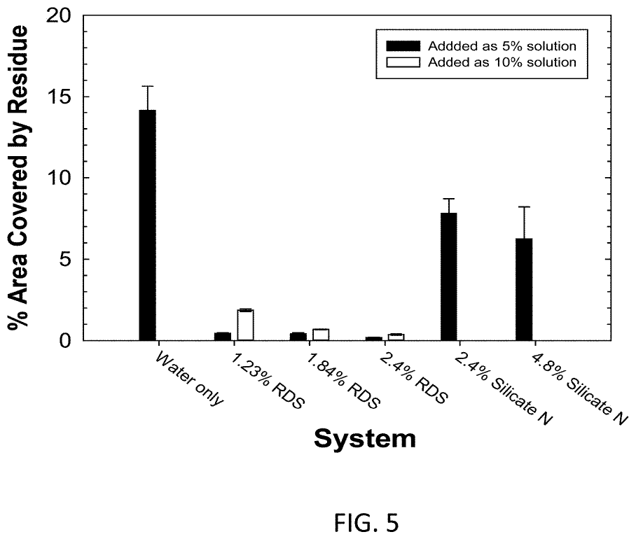

In order to quantify the difference between the imaged samples, image analyses were performed on each of the samples using ImageJ software, an open source Java image processing program developed by the National Institutes of Health (NIH) Image. The results of the image analyses are illustrated in FIG. 5, which shows a plot of the percent area covered by residue in the imaged samples. The values in FIG. 5 represent an average of the percent area covered assessed from two images per sample. As shown in FIG. 5, all samples treated with Laponite RDS exhibited significantly lower degrees of residue transfer when compared to the samples treated with non-layered amorphous silicate (samples 7 and 8) and the sample treated with water-only (sample 9). In particular, all samples treated with Laponite RDS (e.g., samples 1-6) exhibited a reduction in the percent area covered by residue of at least 5% when compared to the samples treated with the non-layered amorphous silicate (samples 7 and 8) and a reduction in the percent area covered by residue of at least 10% when compared to the samples treated with water only. In addition, it should be noted that samples 1-3 (treated with a 5% solution of Laponite RDS) exhibited slightly better results than samples 4-6 (treated with a 10% solution of Laponite RDS). Without intending to be bound by theory, the better performance of the samples treated with the 5% Laponite RDS solution is presumed to be attributable to the better distribution/coating of the layered silicate on the particles of DE when applied as a solution with a lower concentration.

Use of the words “about” and “substantially” herein are understood to mean that values that are listed as “about” a certain value or “substantially” a certain value may vary by an industry recognized tolerance level for the specified value. When an industry recognized tolerance is unavailable, it is understood that such terminology may indicate that an acceptable value may be vary ±3%, ±2%, or ±1% from the specifically listed value.

Many modifications and other embodiments of the disclosure set forth herein will come to mind to one skilled in the art to which these disclosures pertain having the benefit of the teachings presented in the foregoing descriptions. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

1. An animal litter composition comprising:
a plurality of particles of a diatomaceous earth (DE) material; and
a layered silicate at least partially coating the individual particles of the DE material.

2. The animal litter composition of claim 1, wherein the layered silicate is selected from the group consisting of Laponite RD, Laponite DF, Laponite DS, Laponite RDS, and combinations thereof.

3. The animal litter composition of claim 1, wherein the layered silicate is present in an amount of about 1% to about 3% by dry weight, based on the total dry weight of the coated DE material.

4. The animal litter composition of claim 1, wherein the animal litter composition further comprises one or more additives selected from the group consisting of fillers, clumping agents, de-dusting agents, fragrances, bicarbonates, binders, and preservatives.

5. The animal litter composition of claim 1, wherein the animal litter composition is effective to reduce a mass of particle fines adhering to a surface contacting the animal litter by at least about 5% relative to an animal litter of identical composition, but that does not include the layered silicate.

6. A method of reducing transfer of fines from a particulate composition, the method comprising contacting particles of a diatomaceous earth (DE)-based material with a content of a solution comprising a layered silicate in an aqueous solvent so that the layered silicate is at least partially coated on the particles of the DE-based material, the presence of the layered silicate on the particles of the DE-based material being effective to reduce transfer of fines of the DE-based material from the particles to a surface contacting the particles.

7. The method of claim 6, wherein the particulate composition is a pet litter composition and the presence of the layered silicate on the particles of the DE-based material is effective to reduce the transfer of fines of the DE-based material from the particles to a pet surface contacting the particles in the pet litter composition.

8. The method of claim 6, wherein the solution is in the form of a sol or gel.

9. The method of claim 6, wherein the aqueous solvent is water.

10. The method of claim 6, wherein the layered silicate is selected from the group consisting of Laponite RD, Laponite DF, Laponite DS, Laponite RDS, and combinations thereof.

11. The method of claim 6, wherein the solution comprises about 0.1% to about 10% layered silicate by weight, based on the total weight of the solution.

12. The method of claim of claim 6, wherein the presence of the layered silicate on the particles of the DE-based material is effective to reduce the mass of particle fines adhering to a surface contacting the pet litter by at least about 5% relative to a pet litter of identical composition, but that does not include the layered silicate.

13. A method of preparing an animal litter composition, the method comprising combining particles of a diatomaceous earth (DE)-based material with a layered silicate such that the layered silicate at least partially coats, individually, at least a portion of the particles of the DE-based material.

14. The method of claim 13, further comprising combining the particles of the DE-based material including the layered silicate with one or more additives selected from the group consisting of fillers, clumping agents, de-dusting agents, fragrances, bicarbonates, binders, and preservatives.

15. The method of claim 13, wherein the layered silicate is in the form of a sol or gel when combined with the particles of the DE-based material.

16. The method of claim 13, further comprising drying the animal litter composition after combination of the particles of the DE-based material with the layered silicate.

17. The method of claim 13, wherein the layered silicate is provided as a solution of the layered silicate in an aqueous solvent.

18. The method of claim 17, wherein the layered silicate is selected from the group consisting of Laponite RD, Laponite DF, Laponite DS, Laponite RDS, and combinations thereof.

19. The method of claim 18, wherein the layered silicate solution comprises about 0.1% to about 10% layered silicate by weight, based on the total weight of the layered silicate solution.

20. The method of claim 13, wherein the layered silicate is combined with the particles of the DE-based material in a sufficient amount to reduce a mass of particle fines adhering to a surface contacting the animal litter by at least about 5% relative to an animal litter of identical composition, but that does not include the layered silicate.

21. The method of claim 20, wherein the layered silicate is combined with the particles of the DE-based material in a sufficient amount so that the layered silicate is present in the animal litter composition in an amount of about 1% to about 3% by dry weight, based on the total dry weight of the coated DE-based material.
